(19) United States
(12) Patent Application Publication
(10) Pub. No.: US 2026/0200528 A1
(43) Pub. Date: Jul. 16, 2026

(54) COORDINATION OF ACTIVE FRONT AND REAR STEERING AND TORQUE VECTORING WITH ADVANCED DRIVER ASSISTANCE SYSTEMS

(71) Applicant: GM GLOBAL TECHNOLOGY OPERATIONS LLC, DETROIT, MI (US)

(72) Inventors: Nikolai K. Moshchuk, Grosse Pointe Farms, MI (US); Reza Hajiloo, Richmond Hill (CA); Arash Hashemi, Waterloo (CA); Mansour Ataei, Richmond Hill (CA); SeyedAlireza Kasaiezadeh Mahabadi, Waterloo (CA)

(21) Appl. No.: 19/021,383

(22) Filed: Jan. 15, 2025

(51) Int. Cl. B62D 7/15

(52) U.S. Cl. CPC B62D 7/159

(57) ABSTRACT

A method includes receiving a desired state from a path planner, the desire state including at least a first desired yaw rate of the vehicle and a first desired lateral velocity of the vehicle. The method further includes determining, by a path tracking controller based at least in part on the first desired yaw rate and the first desired lateral velocity, a second desired yaw rate of the vehicle and a second desired lateral velocity of the vehicle. The method further includes determining, by a vehicle motion controller based at least in part on the second desired yaw rate and the second desired lateral velocity, an active rear steering command and a torque vectoring command. The method further includes controlling the vehicle using at least one of the active rear steering command and the torque vectoring command to cause the vehicle to follow a path generated by the path planner.

### BACKGROUND

The subject disclosure relates to vehicles, and in particular to coordination of active front and rear steering and torque vectoring with advanced driver assistance systems.

Modern vehicles (e.g., a car, a motorcycle, a boat, or any other type of automobile) may be equipped with one or more cameras that provide back-up assistance, take images of the vehicle driver to determine driver drowsiness or attentiveness, provide images of the road as the vehicle is traveling for collision avoidance purposes, provide structure recognition (e.g., roadway signs, etc.), and/or the like, including combinations and/or multiples thereof. For example, a vehicle can be equipped with multiple cameras, and images from multiple cameras (referred to as “surround view cameras”) can be used to create a “surround” or “bird's eye” view of the vehicle. Some of the cameras (referred to as “long-range cameras”) can be used to capture long-range images (e.g., for object detection for collision avoidance, structure recognition, etc.).

Such vehicles can also be equipped with sensors such as a radar device(s), lidar device(s), and/or the like for perception tasks. Radar (radio detection and ranging) is a technology that uses radio waves to detect and determine the distance, speed, and angle of objects. Radar works by emitting radio signals that bounce off objects and return to the radar system, where the reflected waves are analyzed based on the amount of time between emission and reception. The measured time can be used to determine the distance between the radar device and the detected object, which can be used when performing perception tasks.

Perception tasks can include one or more of object detection, classification, tracking, lane detection, road sign recognition, and obstacle avoidance. Perception tasks are particularly useful for an autonomous or semi-autonomous vehicle to provide the vehicle with real-time awareness of its environment to make safe and informed driving decisions. Images from the one or more cameras of the vehicle can also be used for detecting objects, tracking targets, and/or the like, including combinations and/or multiples thereof. Perception tasks are useful for implementing advanced driver assistance systems (ADASs).

The desire for precise vehicle control using ADASs is important for efficient operation of the vehicle, including the desire for coordination of active front and rear steering and torque vectoring with advanced driver assistance systems.

### SUMMARY

In one embodiment, a computer-implemented method for controlling a vehicle is provided. The method includes receiving a desired state from a path planner, the desire state including at least a first desired yaw rate of the vehicle and a first desired lateral velocity of the vehicle. The method further includes determining, by a path tracking controller based at least in part on the first desired yaw rate and the first desired lateral velocity, a second desired yaw rate of the vehicle and a second desired lateral velocity of the vehicle. The method further includes determining, by a vehicle motion controller (VMC) based at least in part on the second desired yaw rate and the second desired lateral velocity, an active rear steering command and a torque vectoring command. The method further includes controlling the vehicle using at least one of the active rear steering command and the torque vectoring command to cause the vehicle to follow a path generated by the path planner.

In addition to one or more of the features described herein, or as an alternative, further embodiments of the method may include determining, by the path tracking controller, an active front steering command based at least in part on the first desired yaw rate and the first desired lateral velocity.

In addition to one or more of the features described herein, or as an alternative, further embodiments of the method may include controlling the vehicle using the active front steering command to cause the vehicle to follow the path generated by the path planner.

In addition to one or more of the features described herein, or as an alternative, further embodiments of the method may include generating a feedback signal from the VMC.

In addition to one or more of the features described herein, or as an alternative, further embodiments of the method may include that the feedback signal is transmitted from the VMC to the path tracking controller.

In addition to one or more of the features described herein, or as an alternative, further embodiments of the method may include that the feedback signal is transmitted from the VMC to the path planner.

In addition to one or more of the features described herein, or as an alternative, further embodiments of the method may include performing a lateral offset detection to determine a lateral offset of the vehicle.

In addition to one or more of the features described herein, or as an alternative, further embodiments of the method may include performing a yaw offset detection to determine a yaw offset of the vehicle.

In addition to one or more of the features described herein, or as an alternative, further embodiments of the method may include determining whether at least one of the lateral offset of the vehicle of the vehicle exceeds a lateral offset threshold or the yaw offset of the vehicle exceeds a yaw offset threshold.

In addition to one or more of the features described herein, or as an alternative, further embodiments of the method may include, responsive to determining that at least one of the lateral offset of the vehicle of the vehicle exceeds the lateral offset threshold or the yaw offset of the vehicle exceeds the yaw offset threshold, updating the desired state by including path tracking offsets.

In addition to one or more of the features described herein, or as an alternative, further embodiments of the method may include that at least one of the path tracking controller or the VMC implements a cost function.

In another embodiment, a vehicle is provided. The vehicle includes a vehicle plant for controlling the vehicle and a processing system. The processing system includes a memory having computer readable instructions and a processing device for executing the computer readable instructions, the computer readable instructions controlling the processing system to perform operations. The operations include receiving a desired state from a path planner, the desire state comprising at least a first desired yaw rate of the vehicle and a first desired lateral velocity of the vehicle. The operations further include determining, by a path tracking controller based at least in part on the first desired yaw rate and the first desired lateral velocity, a second desired yaw rate of the vehicle and a second desired lateral velocity of the vehicle. The operations further include determining, by a vehicle motion controller (VMC) based at least in part on the second desired yaw rate and the second desired lateral velocity, an active rear steering command and a torque vectoring command. The operations further include causing the vehicle plant to control the vehicle using at least one of the active rear steering command and the torque vectoring command to cause the vehicle to follow a path generated by the path planner.

In addition to one or more of the features described herein, or as an alternative, further embodiments of the vehicle may include that the operations further include determining, by the path tracking controller, an active front steering command based at least in part on the first desired yaw rate and the first desired lateral velocity.

In addition to one or more of the features described herein, or as an alternative, further embodiments of the vehicle may include that the operations further include causing the vehicle plant to control the vehicle using the active front steering command to cause the vehicle to follow the path generated by the path planner.

In addition to one or more of the features described herein, or as an alternative, further embodiments of the vehicle may include that the operations further include generating a feedback signal from the VMC.

In addition to one or more of the features described herein, or as an alternative, further embodiments of the vehicle may include that the feedback signal is transmitted from the VMC to the path tracking controller and to the path planner.

In addition to one or more of the features described herein, or as an alternative, further embodiments of the vehicle may include that the operations further include performing a lateral offset detection to determine a lateral offset of the vehicle, performing a yaw offset detection to determine a yaw offset of the vehicle, determining whether at least one of the lateral offset of the vehicle of the vehicle exceeds a lateral offset threshold or the yaw offset of the vehicle exceeds a yaw offset threshold, and responsive to determining that at least one of the lateral offset of the vehicle of the vehicle exceeds the lateral offset threshold or the yaw offset of the vehicle exceeds the yaw offset threshold, updating the desired state by including path tracking offsets.

In another embodiment a computer program product is provided. The computer program product includes a set of one or more computer-readable storage media and program instructions, collectively stored in the set of one or more storage media, for causing a processor set to perform computer operations. The operations include receiving a desired state from a path planner, the desire state comprising at least a first desired yaw rate of a vehicle and a first desired lateral velocity of the vehicle. The operations further include determining, by a path tracking controller based at least in part on the first desired yaw rate and the first desired lateral velocity, a second desired yaw rate of the vehicle and a second desired lateral velocity of the vehicle. The operations further include determining, by a vehicle motion controller (VMC) based at least in part on the second desired yaw rate and the second desired lateral velocity, an active rear steering command and a torque vectoring command. The operations further include causing a vehicle plant of the vehicle to control the vehicle using at least one of the active rear steering command and the torque vectoring command to cause the vehicle to follow a path generated by the path planner.

In addition to one or more of the features described herein, or as an alternative, further embodiments of the computer program product may include that the operations further include determining, by the path tracking controller, an active front steering command based at least in part on the first desired yaw rate and the first desired lateral velocity and causing the vehicle plant to control the vehicle using the active front steering command to cause the vehicle to follow the path generated by the path planner.

In addition to one or more of the features described herein, or as an alternative, further embodiments of the computer program product may include that the operations further include generating a feedback signal from the VMC, wherein the feedback signal is transmitted from the VMC to the path tracking controller and to the path planner.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 illustrates a vehicle with a processing system and a sensor according to one or more embodiments;

FIG. 2 illustrates the processing system of FIG. 1 according to one or more embodiments;

FIG. 3 illustrates a block diagram of a system for scenario-based engagement of a model predictive controller for controlling a vehicle according to one or more embodiments;

FIG. 4 illustrates a diagram of a path of a vehicle according to one or more embodiments;

FIG. 5A illustrates a diagram of a path of a vehicle according to one or more embodiments;

FIG. 5B illustrates a diagram of a path of a vehicle according to one or more embodiments;

FIG. 6 illustrates a flow diagram of a method for updating states based on path tracking offsets is provided according to one or more embodiments according to one or more embodiments; and

FIG. 7 illustrates a flow diagram of a method for coordination of active front and rear steering and torque vectoring with advanced driver assistance systems according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

As used herein, the term “controller” (e.g., a charging controller as further described herein) refers to a dedicated controller including a processor and a memory, a general controller including control modules configured to enact a control process using the dedicated controller, a network of multiple distinct controllers in communication with each other and each including processors and memory and being configured to cooperatively implement the control process, and any similar configuration for implementing the control process.

One or more embodiments described herein relates to coordination of active front and rear steering and torque vectoring with advanced driver assistance systems for vehicles.

Vehicles may use advanced driver assistance systems (ADASs) to improve vehicle performance and enhance driving comfort by providing automating, adapting, or enhancing vehicle systems to provide better awareness, decision-making, and control.

One example of an ADAS is an adaptive cruise control (ACC) system, which automatically adjusts the velocity of a vehicle to maintain a safe following distance from another vehicle ahead of the vehicle. Another example of an ADAS is an automated lane change (ALC) system to cause the vehicle to perform a lane change. Another example of an ADAS is a front collision alert (FCA) system to generate an alert to an operator of the vehicle warning of a potential front collision. Another example of an ADAS is a collision imminent braking (CIB) system to apply brakes of the vehicle to reduce a velocity of the vehicle. Another example of an ADS is an automated evasive steering (AES) system to adjust the trajectory of the vehicle.

ADASs often use data (referred to as “sensor data”) from sensors (e.g., radar sensors, lidar sensors, proximity sensors, etc.), images from cameras, and/or the like, including combinations and/or multiples thereof, to perform perception tasks, make decisions, and control one or more aspects of the vehicle. Modern vehicle systems rely on advanced technologies to perform perception tasks, such as detecting, classifying, and tracking objects. These capabilities are useful for systems that enable accurate and efficient navigation, including semi-autonomous or autonomous operation of a vehicle, by understanding, in real-time, an environment of the vehicle.

Current control methodologies for ADAS do not fully exploit the capabilities of active front steering (AFS), active rear steering (ARS), and torque vectoring (TV) actuations. This limitation results in suboptimal performance, particularly in scenarios relying on precise vehicle control and agility.

Existing solutions typically involve separate control strategies for ADAS and vehicle motion control (VMC). ADAS control generally includes AFS, while VMC encompasses ARS and TV. The lack of an appropriate interface between ADAS and VMC controllers leads to inefficient coordination between AFS, ARS, and TV actuations. This inefficiency becomes evident in situations where the front steering reaches the saturation point, limiting the vehicle's ability to generate additional lateral force. Additionally, the agility of the vehicle is compromised during evasive maneuvers, where time to collision is a factor. Excessive corrective front steering commands in ADAS hands-on modes can also cause undesirable driver experiences, potentially leading to driver behavior and safety risks.

There are many use cases that show existing ADAS lateral control with only front steering has performance limitations, especially when the front steering becomes saturated and cannot provide more front lateral force. Another issue is the controller's agility, especially in evasive maneuvers when time to collision is an important parameter. Moreover, excessive corrective front steering commands in ADAS hands-on modes can cause undesirable feelings for the driver, causing the driver to behave unexpectedly and cause risks. Proper coordination of front steering with additional actuations in VMC, such as active rear steering and torque vectoring, can improve the performance of ADAS features and extend the operational working range of the ADAS features.

One or more embodiments described herein address these issues by optimizing the coordination between ADAS and VMC controllers. The architecture described according to one or more embodiments includes a path tracking controller (also described as an “L1 engine”) that integrates existing ADAS control features and provides AFS commands and desired states. Additionally, an integrated VMC ARS-TV controller (also described as a “VMC controller” and/or an “L2 engine”) is used to align VMC actuators optimally. The L1 engine and the L2 engine communicate with one another by sending desired states from L1 to L2 to enable VMC to assist ADAS path tracking performance more effectively. An information-sharing interface has also been designed to relay low-level actuation constraints from L2 to L1 and a path planner, ensuring that actuator capabilities are considered and preventing excessive AFS commands requests and unnecessary actuator saturation. The design according to one or more embodiments expands the operating range of ADAS features and enhances their performance with minimal software changes. According to one or more embodiments, better hands-on steering feel, lower time to collision, and less off-tracking (e.g., reducing change of collision) are realized. Alternatively or additionally, one or more embodiments provides improved scalability and modularity while requiring reduced calibration effort and software maintenance.

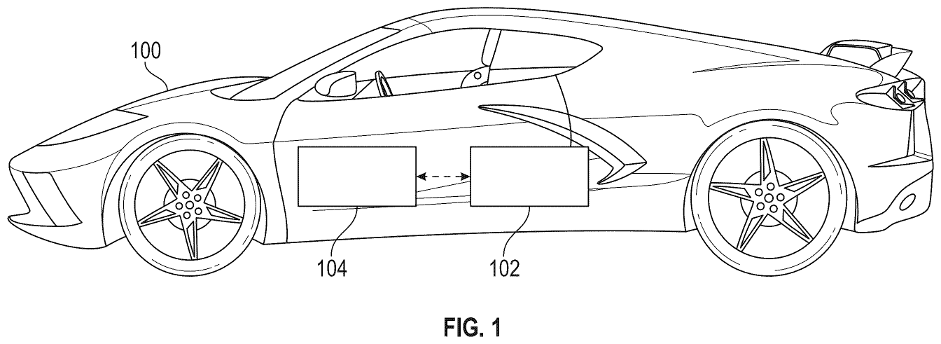

FIG. 1 shows a vehicle 100 with a processing system 102 and sensor 104 according to one or more embodiments. The vehicle 100 can be a car, a truck, a van, a bus, a motorcycle, a boat, or any other type of automobile. According to an embodiment, the vehicle 100 is a hybrid electric vehicle (HEV), such as a plug-in hybrid electric vehicle (PHEV), partially or wholly powered by electrical power. According to another embodiment, the vehicle 100 is an electric vehicle (EV) powered by electrical power. A battery (not shown) is used to provide electrical power to components of the vehicle 100, such as an electric motor (not shown), electrical components (not shown), and/or the like, including combinations and/or multiples thereof. According to one or more embodiments, the vehicle 100 includes an internal combustion engine (not shown) that provides electrical and/or mechanical energy for providing propulsion to the vehicle 100. According to one or more embodiments, the vehicle 100 is an autonomous or semi-autonomous vehicle. An autonomous vehicle is a vehicle that has self-driving capabilities. A semi-autonomous vehicle is a vehicle that has certain autonomous features (e.g., self-parking, lane keeping, etc.) but lacks full autonomous control.

The processing system 102 is located within the vehicle and is responsible for, among other things, managing and processing data collected by the sensor 104. The processing system 102 is responsible for overseeing and/or implementing ADAS functionality according to one or more embodiments using data collected by the sensor 104. The sensor 104 represents one or more sensors, which may vary in type. The sensor 104 may be any suitable sensor(s) and/or combination of sensors, such as a camera, a radar device, a lidar device, a proximity sensor, and/or the like, including combinations and/or multiples thereof. The arrows between the sensor 104 and the processing system 102 indicate the flow of data from the sensor 104 to the processing system 102, highlighting the interaction between these components. This setup enables the vehicle 100 to perform tasks perception tasks, which can be used for autonomous driving for example, using the data collected by the sensor 104. According to one or more embodiments, the processing system 102 can be used to oversee and/or implement features and functionality of one or more ADAS as further described herein.

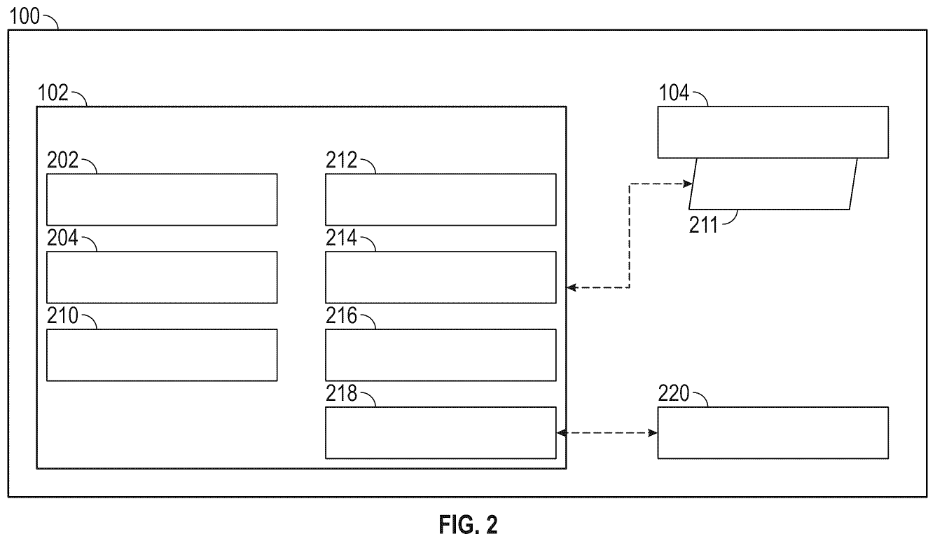

Further features of the processing system 102 and the sensor 104 are now described with reference to FIG. 2.

Particularly, FIG. 2 illustrates the processing system of FIG. 1 according to one or more embodiments. According to one or more embodiments, the processing system 102 includes a processing device 202, a memory 204, a perception engine 210, a path planner engine, an L1 (level one) engine 214, and an L2 (level two) engine 216, and an ADAS engine 218. The L1 engine 214 is also referred to as a “path tracking controller,” and the L2 engine 216 is also referred as a “VMC controller.” It should be appreciated that the processing system 102 can be any device suitable for coordination of active front and rear steering and torque vectoring with ADAS for a vehicle. For example, the processing system 102 can be a device implemented in or otherwise associated with the vehicle 100, such as an electronic control unit (also referred to as an electronic control module). As another example, the processing system 102 can be a smartphone, tablet computer, laptop computer, desktop computer, wearable computing device, and/or the like, including combinations and/or multiples thereof.

The processing device 202 is responsible for executing instructions and managing the overall operation of the processing system 102. The processing device 202 can be any suitable processing circuitry for executing instructions and processing data. For example, the processing device 202 can be a microcontroller, microprocessor, application-specific integrated circuit (ASIC), or any other type of processing unit capable of handling the computational demands of the processing system 102.

The memory 204 stores data (e.g., data 211), computer-readable instructions, and algorithms useful for operation of the processing system 102. This may include real-time data processing, historical data analysis, and storage of firmware or software programs. The memory 204 is any suitable device for storing data, such as the data 211, and/or instructions. For example, the memory 204 can be a combination of volatile memory (e.g., random access memory) and non-volatile memory (e.g., read-only memory, flash memory).

The processing system 102 receives data 211 (from the sensor 104) about the vehicle 100 (e.g., telemetry data about the vehicle) and/or about the environment in which the vehicle is operating (e.g., images of objects in the environment, point cloud data of objects in the environment, etc.). According to one or more embodiments, the data 211 can be images of a lane in which the vehicle 100 is traveling, including any lane markers (e.g., lane lines, turn indicators, etc.) of the lane. The data 211 can be useful, for example, for performing perception tasks, which in turn are used to control the vehicle using an ADAS.

The perception engine 210 performs one or more perception tasks, which can include one or more of object detection, classification, tracking, lane detection, road sign recognition, and obstacle avoidance. Perception tasks are particularly useful for an autonomous vehicle or semi-autonomous vehicle to provide the vehicle with real-time awareness of its environment to make safe and informed driving decisions.

The path planner engine 212 provides a planned path for the vehicle 100 to follow. This planned path could be the center of the lane, a path to avoid an obstacle, etc. Path planner engine 212 determines and provides a desired yaw rate (r_{des_L1}) and a desired lateral velocity (v_{y,des_L1}) based on the inputs received from the perception engine 210.

The L1 engine 214, also referred to as the “path tracking controller,” provides for integrating existing ADAS control features and provide AFS commands and desired states. The L1 engine 214 is responsible for determining a second desired yaw rate (r_{des_L2}) and a second desired lateral velocity (v_{y,des_L2}) based on the inputs received from the path planner engine 212.

L2 engine 216, also referred to as the “VMC controller,” optimizes the alignment and coordination of VMC actuators, specifically ARS and TV, to enhance the performance of ADAS features. The L2 engine 216 operates by receiving desired states from the L1 engine 214, which include the second desired yaw rate (r_{des_L2}) and the second desired lateral velocity (v_{y,des_L2}). Based on these inputs, the L2 engine 216 determines the appropriate ARS command(s) and TV commands to achieve a desired vehicle motion. The L2 engine 216 ensures that the actuators (e.g., within the vehicle plant 220) of the vehicle 100 are utilized effectively to support the path tracking performance and overall vehicle stability.

The ADAS engine 218 implements ADAS functionality and/or controls an ADAS system (not shown). According to one or more embodiments, the ADAS engine 218 interfaces with a vehicle plant 220 that controls electromechanical components of the vehicle, such as actuators, that in turn control aspects of the vehicle, such as steering, braking, acceleration, and/or the like, including combinations and/or multiples thereof. For example, the vehicle plant 220 includes steering actuator or other vehicle actuators, to control the vehicle 100 to follow a planned path from the path planner engine 212.

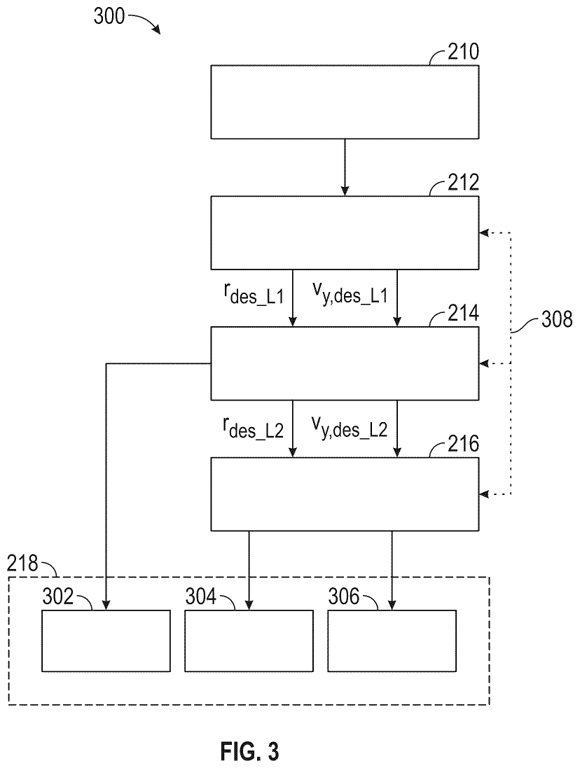

Features and functions of the perception engine 210, the path planner engine 212, the L1 engine 214, the L2 engine 216, and the ADAS engine 218 are further described with respect to FIGS. 3-7.

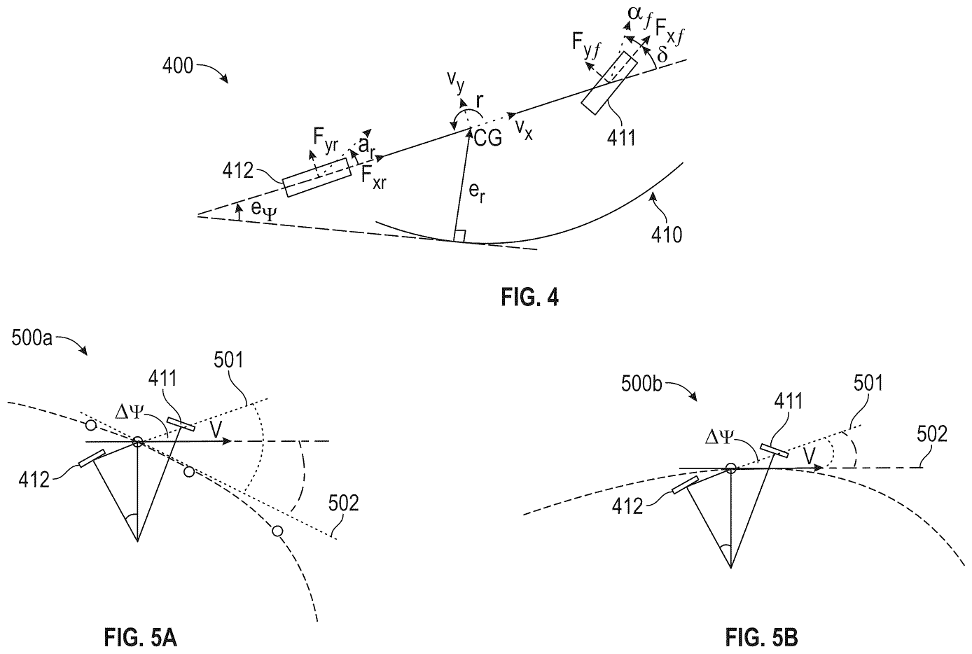

Turning now to FIG. 3, a block diagram of a system 300 for scenario-based engagement of a model predictive controller for controlling the vehicle 100 is provided according to one or more embodiments. The system 300 is designed to optimize the coordination between ADAS and VMC systems, specifically focusing on the integration of AFS, ARS, and TV actuations. The system 300 is now described in more detail with reference to features of FIGS. 1 and 2 as well as with reference to FIGS. 4, 5A, and 5B. In particular, FIG. 4 illustrates a diagram 400 of a path of a vehicle according to one or more embodiments. Similarly, FIGS. 5A and 5B illustrates diagrams 500a, 500b of a path of a vehicle according to one or more embodiments.

The system 300 includes perception engine 210, path planner engine 212, L1 engine 214, L2 engine 216, and ADAS engine 218, which implements one or more of AFS commands 302, ARS commands 304, and TV commands 306 using vehicle plant 220.

Path planner engine 212 is responsible for generating the desired trajectory or path for the vehicle 100 to follow. Path planner engine 212 provides the initial desired states, including a first desired yaw rate (r_{des_L1}) and a first desired lateral velocity (v_{y,des_L1}), which are used as inputs for the subsequent control processes.

L1 engine 214 receives the desired states from the path planner engine 212 and calculates the AFS commands 302 to ensure the vehicle 100 follows the planned path. L1 engine 214 also determines a second desired yaw rate (r_{des_L2}) and a second desired lateral velocity (v_{y,des_L2}) based on the inputs from the path planner.

L1 engine 214 operates by utilizing a four-state vehicle model to track the path and provide the necessary commands to ensure the vehicle follows the planned path accurately. The four-state model, also referred to as a four degree of freedom model, includes a bicycle vehicle model and two error states for lateral and heading deviations. The path planner engine 212 provides the desired trajectory for the vehicle 100, and the L1 engine 214 uses the four-state vehicle model to calculate a predicted error against the desired trajectory.

More particularly, the four-state vehicle model includes states (x) for lateral deviation error (e_{y}), heading deviation error (e_{ψ}), lateral velocity (v_{y}), and yaw rate (r). The L1 engine 214 calculates the predicted error against the desired trajectory provided by the path planner and adjusts the AFS commands 302 accordingly to minimize this error.

With reference to FIGS. 3 and 4, the states (x) can be defined according to the following equations:

$$x = [ \begin{matrix}{e}_{y} & {v}_{y} & {e}_{ψ} & r\end{matrix} ] , u = {δ}_{f}$$

$$\dot{x} = A x + B u + d ,$$

$$y = x ,$$

$$A = [ \begin{matrix}0 & 1 & {v}_{x} & - {e}_{x} \\ 0 & - \frac{{C}_{f} + {C}_{r}}{m {v}_{x}} & 0 & - {v}_{x} - \frac{{l}_{f} {C}_{f} - {l}_{r} {C}_{r}}{m {v}_{x}} \\ 0 & 0 & 0 & 1 \\ 0 & - \frac{{l}_{f} {C}_{f} - {l}_{r} {C}_{r}}{{I}_{z} {v}_{x}} & 0 & - \frac{{l}_{f}^{2} {C}_{f} + {l}_{r}^{2} {C}_{r}}{{I}_{z} {v}_{x}}\end{matrix} ]$$

$$B = [ \begin{matrix}0 \\ \frac{{C}_{f}}{m} \\ 0 \\ \frac{{C}_{f} {l}_{f}}{{I}_{z}}\end{matrix} ]$$

$$d = [ \begin{matrix}0 \\ 0 \\ - {r}_{d e s} \\ 0\end{matrix} ]$$

where u represents an input, δ_{f} represents front steering, \dot{x} represents the derivative of the states (x) with respect to time, d represents a disturbance term in the state-space model, A is a state matrix in the state-space model, B is an input matrix in the state-space model, y is an output term in the state-space model, C_{f} represents afront cornering stiffness, Cᵣ represents a rear cornering stiffness, l_{f} represents a distance from a center of mass of the vehicle to a front axle of the vehicle, lᵣ represents a distance from the center of mass of the vehicle to a rear axle of the vehicle, I_{z} represents a yaw moment of inertia, m represents a mass of the vehicle, vₓ represents a longitudinal velocity of the vehicle, eₓ represents a longitudinal deviation error, and r_{des} is a desired yaw rate.

In FIG. 4, a desired trajectory 410 is shown, along with a front wheel 411 and a rear wheel 412 of the vehicle 100. Using information from FIG. 4, the lateral deviation error ė_{y} can be determined using the following equations:

$${\dot{e}}_{y} = {v}_{x} {e}_{ψ} + {v}_{y} - {e}_{x} r ( r = \dot{ψ} )$$

$$\frac{d {e}_{ψ}}{dt} = r - {r}_{d e s} ( {r}_{d e s} = {\dot{ψ}}_{r e f} )$$

with the following constraints:

$${u}_{min} < u < {u}_{max}$$

$${\dot{u}}_{min} < \dot{u} < {\dot{u}}_{max}$$

where vₓ represents a longitudinal velocity of the vehicle, e_{ψ} represents heading deviation error, v_{y} represents a lateral velocity of the vehicle, eₓ represents longitudinal deviation error, r=ψ represent yaw rate, r_{des}=\dot{ψ}_{ref} represents a desired yaw rate (reference yaw rate), u represents an input, uₘᵢₙ and uₘₐₓ represent minimum and maximum input constraint values, it represents an input rate, and \dot{u}ₘᵢₙ and \dot{u}ₘₐₓ represent minimum and maximum input rate constraint values.

In FIG. 4, α_{f} represents a front slip angle of the front wheel 411, αᵣ represents a rear slip angle of the rear wheel 412, F_{xf} front represents a longitudinal tire force, Fₓᵣ represents rear longitudinal tire force, F_{yf} represents a front lateral tire force, F_{yr} represents a rear lateral tire force, δ=δ_{f} represents a front steering command, and CG represent center of gravity of the vehicle 100.

Using these equations and corresponding variables, the L1 engine 214 determines the second desired yaw rate (r_{des_L2}) and the second desired lateral velocity (v_{y,des_L2}). More particularly, the desired states that are sent to the L2 engine 216 are selected to be vehicle states (e.g., velocity states), and the desired position states (e.g., path tracking error states) are not included in the states sent to the L2 engine 216 by assuming that the L2 engine 216 is a VMC and should not include position states. Vehicle level states can be relied on for enhancing path tracking performance (by additional actuators), and the desired vehicle states for the L2 engine 216 can be updated based on path tracking position error states when necessary. The calculation of desired vehicle states for the L2 engine 216 as well as the algorithm to update desired states based on position error states are now described.

For example, for “perfect tracking,” (where the vehicle follows the desired path exactly), linear equations of motion in the vehicle reference framed can be used as follows:

$$Δ \dot{y} = {V}_{y} + {V}_{x} Δ ψ$$

$$Δ \dot{ψ} = r - {V}_{x} ρ$$

$${\dot{V}}_{y} = - \frac{{C}_{f} + {C}_{r}}{M {V}_{x}} {V}_{y} - ( {V}_{x} + \frac{{l}_{f} {C}_{f} - {l}_{r} {C}_{r}}{M {V}_{x}} ) r + \frac{{C}_{f}}{M} {δ}_{f} + \frac{{C}_{r}}{M} {δ}_{r}$$

$$\dot{r} = - \frac{{l}_{f} {C}_{f} - {l}_{r} {C}_{r}}{{I}_{z} {V}_{x}} {V}_{y} - \frac{{l}_{f}^{2} {C}_{f} - {l}_{r}^{2} {C}_{r}}{{I}_{z} {V}_{x}} r + \frac{{l}_{f} {C}_{f}}{{I}_{z}} {δ}_{f} -$$

where perfect tracking, when Δy=0, is expressed as heading equal to negative lateral slip according to the following equation:

$$Δ ψ = - \frac{{V}_{y}}{{V}_{x}}$$

where I_{z} represents a yaw moment of inertia, m represents a mass of the vehicle, C_{f} represents afront cornering stiffness, Cᵣ represents a rear cornering stiffness, ρ represents lane curvature, δᵣ represens a rear steering command, ΔM_{z} represents a torque vectoring command, Δy represents a vehicle center of gravity lateral deviation from the planned path (lateral error), Δψ represents heading angle error, v_{y} represents vehicle lateral velocity, and r represents vehicle raw rate.

FIGS. 5A and 5B depict a tracking path general case (diagram 500a) and a tracking path case (diagram 500b) with zero lateral error (e.g., heading is equal to negative lateral slip), respectively. In these examples, V represents the total vehicle velocity, and vehicle heading 501 and vehicle sideslip 502 are shown.

With continued reference to FIG. 3, the L1 engine 214 can determine the second desired yaw rate (r_{des_L2}) and the second desired lateral velocity (v_{y,des_L2}) based on the following equations for perfect tracking:

$${V}_{y} = ρ {V}_{x} ( {l}_{r} - \frac{{l}_{f} M}{L {C}_{r}} {V}_{x}^{2} ) + \dot{ρ} ( \frac{{I}_{z} + {l}_{f} {l}_{r} M}{L {C}_{r}} {V}_{x}^{2} - {l}_{r}^{2} )$$

$$r = ρ {V}_{x} + \dot{ρ} ( \frac{{l}_{f} M}{L {C}_{r}} {V}_{x}^{2} - {l}_{r} )$$

$${δ}_{f} = ρ ( L + {K}_{u s} {V}_{x}^{2} ) + \dot{ρ} ( \frac{{l}_{f} M}{{C}_{r}} + \frac{{C}_{f} + {C}_{r}}{{C}_{f} {C}_{r}} \frac{{l}_{z}}{L} ) {V}_{x}$$

$${α}_{f} = ρ ( {K}_{u s} + \frac{{l}_{f} M}{{C}_{r} L} ) {V}_{x}^{2} + \dot{ρ} ( \frac{{l}_{r} L}{{V}_{x}} + \frac{{l}_{z}}{{C}_{f} L} {V}_{x} )$$

$${α}_{r} = ρ \frac{{l}_{f} M}{{C}_{r} L} {V}_{x}^{2} - \dot{ρ} \frac{{I}_{z} {V}_{x}}{{C}_{r} L}$$

$${α}_{f} - {α}_{r} = p {K}_{u s} {V}_{x}^{2} + \dot{ρ} ( \frac{{l}_{r} L}{{V}_{x}} + \frac{{I}_{z}}{L} \frac{{C}_{f} + {C}_{r}}{{C}_{f} {C}_{r}} {V}_{x} )$$

$${K}_{u s} = \frac{M}{L} ( \frac{{l}_{r}}{{C}_{f}} - \frac{{l}_{f}}{{C}_{r}} )$$

$$\dot{r} = \dot{ρ} {V}_{x}$$

$${V}_{x} \approx const$$

where Kᵤₛ represents an understeering coefficient, the other variables having already been defined herein.

Based on the foregoing, the desired state calculation using the path information is represented as follows:

$${r}_{des \_ L 2} = {r}_{des \_ L 1} + f ( {e}_{y} , {e}_{ψ} )$$

$${v}_{y , {des}_{L 2}} = {v}_{y , {des}_{L 1}} + g ( {e}_{y} , {e}_{ψ} )$$

which can be simplified as:

$${r}_{des \_ L 2} = {r}_{des \_ L 1} + {k}_{1} {e}_{y} + {k}_{2} {e}_{ψ}$$

$${v}_{y , {des}_{L 2}} = {v}_{y , des\_L 1} + {k}_{3} {e}_{y}$$

where ƒ(e_{y}, e_{ψ}) represents a desired yaw rate adjustment function, g(e_{y}, e_{ψ}) represents a desired lateral velocity adjustment function, and k₁, k₂, k₃ represent adjustment coefficients.

With continued reference to FIG. 3, the L1 engine 214 has path tracking features and considers path information on its states/outputs. On the other hand, the L2 engine 216 does not directly consider path information from path planner engine 212 on its methodology. Existing approaches do not communicate the path tracking performance of the L1 engine 214 to the L2 engine 216. This can be achieved by adjusting the desired states from the path planner engine 212 before sending them to the L2 engine 216 based on the current path tracking errors. In this case, the L2 engine 216 has information on how well the path has been followed and adjusts ARS commands 304 and TV commands 306 accordingly.

As shown, FIG. 3 also includes a feedback mechanism represented by the arrow 308. The feedback mechanism relays information about the actuator capabilities and saturation states from the L2 engine 216 back to the L1 engine 214 and/or to the path planner engine 212. This ensures that the control commands are adjusted based on the current state of the actuators, preventing excessive command requests and avoiding unnecessary actuator saturation.

According to one or more embodiments, the L1 engine 214 and/or the L2 engine 216 can implement a cost function. For example, the L1 engine 214 and/or the L2 engine 216 can implement the following cost function:

$$\frac{1}{2} {\sum }_{k = 1}^{p} \{ {( {y}_{k} - {y}_{ref} )}_{{W}_{y}}^{2} + {( {u}_{k} - {u}_{ref} )}_{{W}_{u}}^{2} + {( {u}_{k} - {u}_{k - 1} )}_{{W}_{Δ u}}^{2} \}$$

where W_{y} represents an output weight in the cost function, Wᵤ represents an input weight in the cost function, W_{Δu} represents an input rate weight in the cost function, uₖ represents an input at time step k, p represents a prediction horizon, y_{ref} represents a desired output, u_{ref} represents a desired input, and yₖ reprenests an output at time step k.

According to one or more embodiments, the path planner engine 212 outputs the first desired yaw rate (r_{des_L1}), the first desired lateral velocity (v_{y,des_L1}), lateral deviation error (e_{y}), and the heading deviation error (e_{ψ}), and the L1 engine 214 outputs the second desired yaw rate (r_{des_L2}), the second desired lateral velocity (v_{y,des_L2}), and a front steering command (δ_{f}).

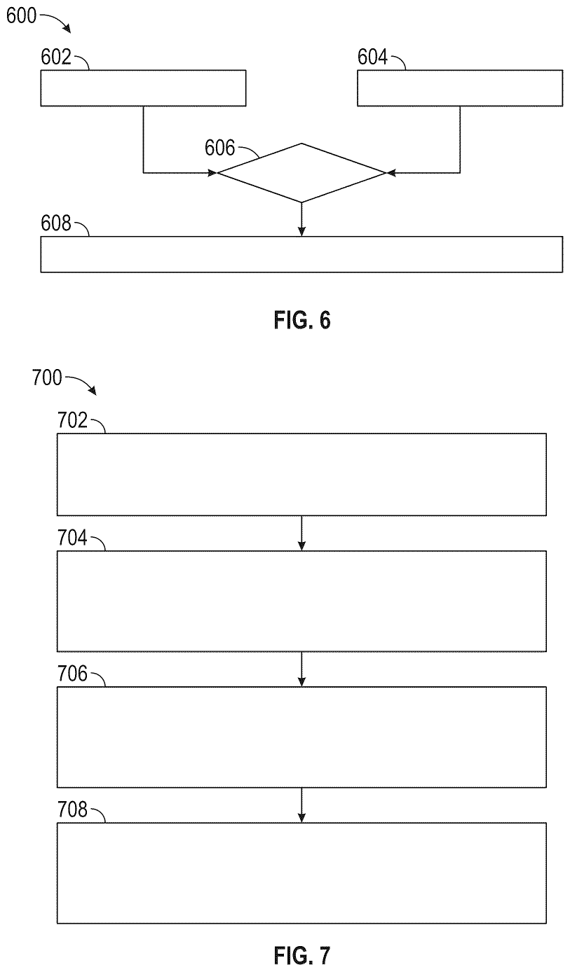

Turning now to FIG. 6, a flow diagram of a method 600 for updating states based on path tracking offsets is provided according to one or more embodiments. The method 600 can be implemented using any suitable system or device. For example, the method 600, and its steps, can be implemented using the processing system 102 of FIGS. 1 and 2.

At block 602, the method 600 begins with performing a lateral offset detection to determine the lateral offset of the vehicle. This step involves detecting any deviation of the vehicle's center of gravity from the planned path, which is useful for maintaining accurate path tracking.

At block 604, the method 600 includes performing a yaw offset detection to determine the yaw offset of the vehicle. This step involves detecting any deviation in the vehicle's heading angle from the desired path, which is useful for ensuring proper vehicle orientation and stability.

At decision block 606, the method 600 includes determining whether at least one of the lateral offset or the yaw offset of the vehicle exceeds a predefined threshold. This step is useful for identifying significant deviations that may require corrective actions to maintain the desired path and vehicle stability.

At block 608, if it is determined at decision block 606 that at least one of the lateral offset or the yaw offset exceeds the respective threshold, the method 600 includes updating the desired states by including path tracking offsets. This step ensures that the vehicle's control commands are adjusted to account for the detected offsets, thereby improving path tracking accuracy and overall vehicle performance.

In summary, FIG. 6 illustrates a method 600 that enhances the coordination of active front and rear steering and torque vectoring with ADAS by incorporating lateral and yaw offset detections, determining offset thresholds, and updating desired states based on the detected offsets. This method ensures precise path tracking, improved vehicle stability, and an overall enhanced driving experience.

Additional processes also may be included, and it should be understood that the processes depicted in FIG. 6 represent illustrations, and that other processes may be added, or existing processes may be removed, modified, or rearranged without departing from the scope of the present disclosure. It should also be understood that the processes depicted in FIG. 6 may be implemented as programmatic instructions stored on a non-transitory computer-readable storage medium that, when executed by a processor (e.g., the processing device 202 of FIG. 2 and/or the like, including combinations and/or multiples thereof) of a computing system (e.g., the processing system 102 of FIGS. 1 and 2 and/or the like, including combinations and/or multiples thereof), cause the processor to perform the processes described herein.

FIG. 7 illustrates a flow diagram of a method 700 for coordination of active front and rear steering and torque vectoring with advanced driver assistance systems according to one or more embodiments. The method 700 can be implemented using any suitable system or device. For example, the method 700, and its steps, can be implemented using the processing system 102 of FIGS. 1 and 2 and/or the like, including combinations and/or multiples thereof. The method 700 is now described with reference to at least portions of FIGS. 1-4 but is not so limited.

At block 702, the method 700 begins with receiving, by a processing system (e.g., processing system 102), desired states from a path planner (e.g., path planner engine 212). The desired states include a first desired yaw rate (r_{des_L1}) and a first desired lateral velocity (v_{y,des_L1}).

At block 704, the method 700 continues with determining, by a path tracking controller (e.g., L1 engine 214) within the processing system 102 based on the first desired yaw rate (r_{des_L1}) and the first desired lateral velocity (v_{y,des_L1}), a second desired yaw rate (r_{des_L2}) and a second desired lateral velocity (v_{y,des_L2}).

At block 706, the method 700 involves determining, by a VMC controller (e.g., L2 engine 216) within the processing system 102 based on the second desired yaw rate (r_{des_L2}) and the second desired lateral velocity (v_{y,des_L2}), an active rear steering command and a torque vectoring command.

At block 708, the method 700 includes controlling the vehicle 100 using at least one of the active rear steering command and the torque vectoring command to cause the vehicle 100 to follow a path generated by the path planner (e.g., path planner engine 212).

The path planner engine 212 and the L1 engine 214 provide the desired trajectory, yaw rate, and lateral velocity, respectively. Actuator capabilities can be considered when determining these values to avoid performance or stability issues for the L1 engine 214. For example, if the front steering is close to saturation, path planner engine 212 and the L1 engine 214 can adjust the request to prevent wheel/axle saturation. Similarly, if one axle is already saturated, both the request and AFS commands 302 can be adjusted. For example, if the front steering is saturated, the L1 engine 214 can reduce the AFS commands 302 and adjust the desired yaw rate and lateral velocity to make better use of the ARS commands 304. The L2 engine 216 can incorporate actuator capability and saturation limits also. The interface design described herein is updated to provide front/rear capability and saturation state information to both the path planner engine 212 and the L1 engine 214. Additionally, the logics in the path planner engine 212 and the L1 engine 214 can be modified to update their outputs based on this new information.

Additional processes also may be included, and it should be understood that the processes depicted in FIG. 7 represent illustrations, and that other processes may be added, or existing processes may be removed, modified, or rearranged without departing from the scope of the present disclosure. It should also be understood that the processes depicted in FIG. 7 may be implemented as programmatic instructions stored on a non-transitory computer-readable storage medium that, when executed by a processor (e.g., the processing device 202 of FIG. 2 and/or the like, including combinations and/or multiples thereof) of a computing system (e.g., the processing system 102 of FIGS. 1 and 2 and/or the like, including combinations and/or multiples thereof), cause the processor to perform the processes described herein.

One or more embodiments offer significant technical benefits. For example, one or more embodiments described herein improve the operation of the vehicle 100 by b optimizing the coordination between advanced driver assistance systems and vehicle motion control systems. This optimization allows for more effective use of active front steering, active rear steering, and torque vectoring actuations, leading to improved vehicle control and agility. By integrating a path tracking controller (e.g., L1 engine 214) with existing ADAS features and introducing an integrated VMC ARS-TV controller (e.g., L2 control engine 216), one or more of the embodiments described herein ensure better alignment and communication between the controllers. This results in more precise path tracking, reduced corrective steering commands, and an overall enhanced driving experience. Additionally, the information-sharing interface prevents actuator saturation and excessive command requests, further expanding the operating range and performance of ADAS features with minimal software changes.

It is understood that one or more embodiments described herein is capable of being implemented in conjunction with any other type of computing environment now known or later developed.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A computer-implemented the method for controlling a vehicle, the method comprising:
receiving a desired state from a path planner, the desire state comprising at least a first desired yaw rate of the vehicle and a first desired lateral velocity of the vehicle;
determining, by a path tracking controller based at least in part on the first desired yaw rate and the first desired lateral velocity, a second desired yaw rate of the vehicle and a second desired lateral velocity of the vehicle;
determining, by a vehicle motion controller (VMC) based at least in part on the second desired yaw rate and the second desired lateral velocity, an active rear steering command and a torque vectoring command; and
controlling the vehicle using at least one of the active rear steering command and the torque vectoring command to cause the vehicle to follow a path generated by the path planner.

2. The computer-implemented method of claim 1, further comprising determining, by the path tracking controller, an active front steering command based at least in part on the first desired yaw rate and the first desired lateral velocity.

3. The computer-implemented method of claim 2, further comprising controlling the vehicle using the active front steering command to cause the vehicle to follow the path generated by the path planner.

4. The computer-implemented method of claim 1, further comprising generating a feedback signal from the VMC.

5. The computer-implemented method of claim 4, wherein the feedback signal is transmitted from the VMC to the path tracking controller.

6. The computer-implemented method of claim 4, wherein the feedback signal is transmitted from the VMC to the path planner.

7. The computer-implemented method of claim 1, further comprising performing a lateral offset detection to determine a lateral offset of the vehicle.

8. The computer-implemented method of claim 7, further comprising performing a yaw offset detection to determine a yaw offset of the vehicle.

9. The computer-implemented method of claim 8, further comprising determining whether at least one of the lateral offset of the vehicle of the vehicle exceeds a lateral offset threshold or the yaw offset of the vehicle exceeds a yaw offset threshold.

10. The computer-implemented method of claim 9, further comprising, responsive to determining that at least one of the lateral offset of the vehicle of the vehicle exceeds the lateral offset threshold or the yaw offset of the vehicle exceeds the yaw offset threshold, updating the desired state by including path tracking offsets.

11. The computer-implemented method of claim 1, wherein at least one of the path tracking controller or the VMC implements a cost function.

12. A vehicle comprising:
a vehicle plant for controlling the vehicle; and
a processing system comprising:
a memory comprising computer readable instructions; and
a processing device for executing the computer readable instructions, the computer readable instructions controlling the processing system to perform operations comprising:
receiving a desired state from a path planner, the desire state comprising at least a first desired yaw rate of the vehicle and a first desired lateral velocity of the vehicle;
determining, by a path tracking controller based at least in part on the first desired yaw rate and the first desired lateral velocity, a second desired yaw rate of the vehicle and a second desired lateral velocity of the vehicle;
determining, by a vehicle motion controller (VMC) based at least in part on the second desired yaw rate and the second desired lateral velocity, an active rear steering command and a torque vectoring command; and
causing the vehicle plant to control the vehicle using at least one of the active rear steering command and the torque vectoring command to cause the vehicle to follow a path generated by the path planner.

13. The vehicle of claim 12, wherein the operations further comprise determining, by the path tracking controller, an active front steering command based at least in part on the first desired yaw rate and the first desired lateral velocity.

14. The vehicle of claim 13, wherein the operations further comprise causing the vehicle plant to control the vehicle using the active front steering command to cause the vehicle to follow the path generated by the path planner.

15. The vehicle of claim 12, wherein the operations further comprise generating a feedback signal from the VMC.

16. The vehicle of claim 15, wherein the feedback signal is transmitted from the VMC to the path tracking controller and to the path planner.

17. The vehicle of claim 12, wherein the operations further comprise:
performing a lateral offset detection to determine a lateral offset of the vehicle;
performing a yaw offset detection to determine a yaw offset of the vehicle;
determining whether at least one of the lateral offset of the vehicle of the vehicle exceeds a lateral offset threshold or the yaw offset of the vehicle exceeds a yaw offset threshold; and
responsive to determining that at least one of the lateral offset of the vehicle of the vehicle exceeds the lateral offset threshold or the yaw offset of the vehicle exceeds the yaw offset threshold, updating the desired state by including path tracking offsets.

18. A computer program product comprising:
a set of one or more computer-readable storage media;
program instructions, collectively stored in the set of one or more storage media, for causing a processor set to perform computer operations comprising:
receiving a desired state from a path planner, the desire state comprising at least a first desired yaw rate of a vehicle and a first desired lateral velocity of the vehicle;
determining, by a path tracking controller based at least in part on the first desired yaw rate and the first desired lateral velocity, a second desired yaw rate of the vehicle and a second desired lateral velocity of the vehicle;
determining, by a vehicle motion controller (VMC) based at least in part on the second desired yaw rate and the second desired lateral velocity, an active rear steering command and a torque vectoring command; and
causing a vehicle plant of the vehicle to control the vehicle using at least one of the active rear steering command and the torque vectoring command to cause the vehicle to follow a path generated by the path planner.

19. The computer program product of claim 18, wherein the operations further comprise:
determining, by the path tracking controller, an active front steering command based at least in part on the first desired yaw rate and the first desired lateral velocity; and
causing the vehicle plant to control the vehicle using the active front steering command to cause the vehicle to follow the path generated by the path planner.

20. The computer program product of claim 19, wherein the operations further comprise generating a feedback signal from the VMC, wherein the feedback signal is transmitted from the VMC to the path tracking controller and to the path planner.
